(19) United States
(12) Patent Application Publication
(10) Pub. No.: US 2026/0288061 A1
(43) Pub. Date: Sep. 24, 2026

(54) IMAGE FORMING SYSTEM

(71) Applicant: FUJIFILM Business Innovation Corp., Tokyo (JP)

(72) Inventors: Maho ITAKURA, Kanagawa (JP); Tatsuro MATSUOKA, Kanagawa (JP); Kazunari ISHII, Kanagawa (JP); Yuka NOMURA, Kanagawa (JP); Natsuki OGAWA, Kanagawa (JP); Narumi NAKAYA, Kanagawa (JP)

(73) Assignee: FUJIFILM Business Innovation Corp., Tokyo (JP)

(21) Appl. No.: 19/264,890

(22) Filed: Jul. 10, 2025

(30) Foreign Application Priority Data
Mar. 24, 2025 (JP) 2025-049116

(51) Int. Cl. G03G 21/20; G03G 15/08; G03G 21/10; G03G 21/12

(52) U.S. Cl. CPC G03G 21/206; G03G 15/0844; G03G 21/105; G03G 21/12; G03G 2221/1645

(57) ABSTRACT

An image forming system includes an image forming unit that forms an image on a medium using toner, a cyclone capturing unit that includes a first suction port through which air containing the toner in the image forming unit is sucked, a second suction port through which air different from the air sucked through the first suction port is sucked from an outside of the image forming unit, a collection portion that collects the toner, and a gas outlet port for discharge of the air and in which the air sucked into the cyclone capturing unit through the first suction port or the second suction port is swirled such that the air and the toner are separated from each other due to a centrifugal force, the toner is captured and collected into the collection portion, and the air is discharged through the gas outlet port, and an opening and closing portion that opens only one of the first suction port and the second suction port, that closes the other of the first suction port and the second suction port, and that opens only the second suction port in a case of cleaning.

### CROSS-REFERENCE TO RELATED APPLICATIONS

This application is based on and claims priority under 35 USC 119 from Japanese Patent Application No. 2025-049116 filed Mar. 24, 2025.

### BACKGROUND

### (i) Technical Field

The present invention relates to an image forming system.

### (ii) Related Art

Disclosed in JP2017-72708A is an image forming apparatus including an image forming unit, a fixation unit, and a toner capturing unit. The image forming unit forms an image by transferring toner to a paper sheet. The fixation unit fixes the image on the paper sheet on which the image is formed by the image forming unit. The toner capturing unit captures the toner by suctioning toner-containing air in the apparatus. The toner capturing unit includes a cyclone unit, a collection portion, a filter unit, an air blowing unit, and a dirt detection unit. In the cyclone unit, the toner is separated from the toner-containing air through centrifugal separation. The collection portion collects the toner separated by the cyclone unit. The filter unit includes a plurality of filters that allow the air, from which the toner is separated by the cyclone unit, to pass therethrough and that collect residual toner. The air blowing unit sucks air. The dirt detection unit detects dirt of the filters. Furthermore, the image forming apparatus includes a controller. The controller executes a cleaning mode for the cyclone unit in a case where the controller determines that a difference between a wind volume estimated from the dirt of the filters that is detected by the dirt detection unit and an actual wind volume measurement value acquired by an air volume detection unit provided at the filter unit exceeds a cyclone cleaning threshold value.

### SUMMARY

Aspects of non-limiting embodiments of the present disclosure relate to an image forming system with which it is possible to efficiently remove toner adhering to a wall surface of a cyclone capturing unit in comparison with a case where toner-containing air in an image forming unit is sucked into the cyclone capturing unit in the case of cleaning.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including an image forming unit that forms an image on a medium using toner, a cyclone capturing unit that includes a first suction port through which air containing the toner in the image forming unit is sucked, a second suction port through which air different from the air sucked through the first suction port is sucked from an outside of the image forming unit, a collection portion that collects the toner, and a gas outlet port for discharge of the air and in which the air sucked into the cyclone capturing unit through the first suction port or the second suction port is swirled such that the air and the toner are separated from each other due to a centrifugal force, the toner is captured and collected into the collection portion, and the air is discharged through the gas outlet port, and an opening and closing portion that opens only one of the first suction port and the second suction port, that closes the other of the first suction port and the second suction port, and that opens only the second suction port in a case of cleaning.

### BRIEF DESCRIPTION OF THE DRAWINGS

Exemplary embodiment(s) of the present invention will be described in detail based on the following figures, wherein:

FIG. 1 is a schematic configuration view showing an example of a configuration of an image forming system according to a first exemplary embodiment;

FIG. 2 is a schematic configuration view showing an example of an image forming unit of the image forming system according to the first exemplary embodiment;

FIG. 3 is a schematic configuration view showing an example of a cyclone device in the image forming system according to the first exemplary embodiment;

FIG. 4 is a configuration view showing the flow of air and toner in the cyclone device shown in FIG. 3;

FIG. 5 is a schematic cross-sectional view showing a state where an opening and closing member of the cyclone device in the image forming system according to the first exemplary embodiment is rotated to a first position;

FIG. 6A is a schematic cross-sectional view showing a state after the opening and closing member of the cyclone device in the image forming system according to the first exemplary embodiment is rotated to a second position and FIG. 6B is a schematic cross-sectional view showing an air inflow path in a state after the opening and closing member of the cyclone device is rotated to the second position; and

FIG. 7 is a block diagram showing an example of a hardware configuration of the image forming system according to the first exemplary embodiment.

### DETAILED DESCRIPTION

Hereinafter, an exemplary embodiment of the present invention will be described. In the following description, a direction represented by an arrow H in the drawings will be referred to as a vertical direction, and a direction represented by an arrow W will be referred to as a horizontal direction, which is an apparatus width direction.

### First Exemplary Embodiment

First, an overall configuration of an image forming system according to a first exemplary embodiment will be described. Thereafter, a configuration of a cyclone device used in the image forming system will be described.

### Overall Configuration of Image Forming System

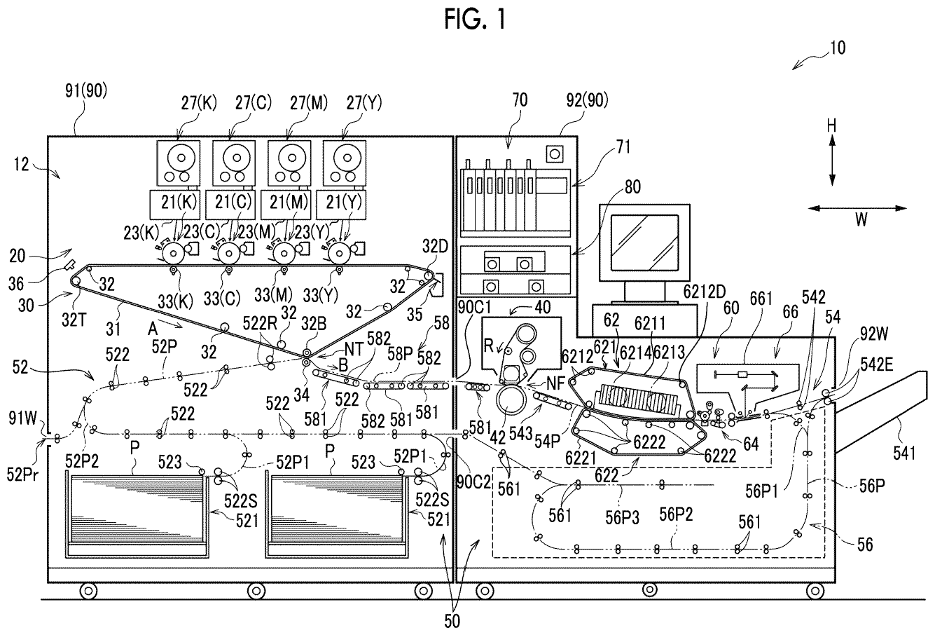

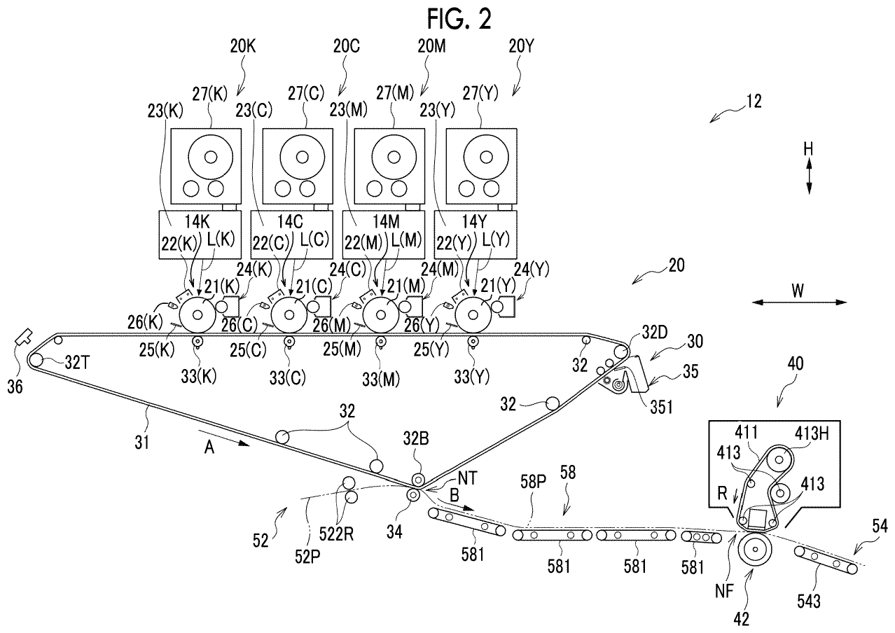

FIG. 1 is a schematic configuration view showing an example of a configuration of the image forming system according to the first exemplary embodiment. FIG. 2 is a schematic configuration view showing a configuration of an image forming unit of the image forming system shown in FIG. 1.

As shown in FIG. 1, an image forming system 10 includes an image forming unit 12 that electrophotographically forms an image on a recording medium P which is an example of a medium, a medium transportation device 50 that transports the recording medium P, and a postprocessing unit 60 that performs postprocessing or the like of the recording medium P on which the image is formed. In addition, the image forming system 10 includes a power supply unit 80 that supplies power to each part of an apparatus and a control unit 70 that controls each part of the apparatus.

The image forming unit 12 includes toner image forming units 20 that form toner images, a transfer device 30 that transfers the toner images formed by the toner image forming units 20 to the recording medium P, and a fixing device 40 that fixes, onto the recording medium P, the toner images transferred to the recording medium P.

The medium transportation device 50 includes a medium supply unit 52 that supplies the recording medium P to the image forming unit 12 and a medium discharge unit 54 that discharges the recording medium P on which the toner images are formed. In addition, the medium transportation device 50 includes a medium return unit 56 and an intermediate transportation unit 58 that are used in a case where images are to be formed on both surfaces of the recording medium P.

The postprocessing unit 60 includes a medium cooling unit 62 that cools the recording medium P to which the toner images are transferred by the image forming unit 12, a correcting device 64 that corrects a bend of the recording medium P, and an image inspection unit 66 that inspects an image formed on the recording medium P. Each part constituting the postprocessing unit 60 is disposed in the medium discharge unit 54 of the medium transportation device 50.

In the case of the image forming system 10, each part except for a discharged medium receiving portion 541 is accommodated in a housing 90. The housing 90 in the present exemplary embodiment has a two-part structure consisting of a first housing 91 and a second housing 92 that are adjacent to each other in the apparatus width direction. Accordingly, the unit of transportation in the image forming system 10 is small in the apparatus width direction.

The first housing 91 accommodates a major part of the image forming unit 12 excluding the fixing device 40 and accommodates the medium supply unit 52. The second housing 92 accommodates the fixing device 40 constituting the image forming unit 12, the medium discharge unit 54, the medium cooling unit 62, the image inspection unit 66, the medium return unit 56, the control unit 70, and the power supply unit 80.

The first housing 91 and the second housing 92 are coupled to each other by means of a coupler such as a bolt and a nut (not shown), for example. Between the first housing 91 and the second housing 92 that are in a state of being coupled to each other in this manner, a communication opening portion 90C1 for the recording medium P that leads to a fixation nip NF from a transfer nip NT of the image forming unit 12 and a communication path 90C2 for the recording medium P that leads to the medium supply unit 52 from the medium return unit 56 are formed.

### Image Forming Unit

Here, the “image forming unit” will be described in detail.

The image forming unit 12 includes the toner image forming units 20, the transfer device 30, and the fixing device 40. In the present exemplary embodiment, toner image forming units 20Y, 20M, 20C, and 20K that respectively form toner images of yellow (Y), magenta (M), cyan (C), and black (K) are provided. The image forming unit 12 forms an image on the recording medium P, which is an example of a medium, by using toners.

The toner image forming units 20Y, 20M, 20C, and 20K are arranged along an upper side portion of a transfer belt 31 in the order of the toner image forming unit 20Y→the toner image forming unit 20M→the toner image forming unit 20C→the toner image forming unit 20K starting from an upstream side in a movement direction of the transfer belt 31. That is, toner images are formed on the transfer belt 31 in the order of a color Y→a color M→a color C→a color K.

The toner image forming units 20Y, 20M, 20C, and 20K are configured in the same manner as each other. In a case where it is not necessary to distinguish the toner image forming units 20Y, 20M, 20C, and 20K by the color thereof, the toner image forming units 20Y, 20M, 20C, and 20K will be collectively referred to as the toner image forming units 20. As shown in FIG. 2, the toner image forming units 20 include image formation units 14 and toner cartridges 27 that hold toners. The image formation units 14 for respective colors will also be described without being distinguished by the color thereof. Each image formation unit 14 includes a photoreceptor drum 21, a charger 22, an exposure device 23, a developing device 24, a cleaning device 25, and a charge erasing device 26. The photoreceptor drum 21 is an example of a photoreceptor.

A photosensitive layer is formed on a surface of the photoreceptor drum 21. The charger 22 charges the surface (the photosensitive layer) of the photoreceptor drum 21 by means of, for example, a corona discharge method or the like. The exposure device 23 irradiates, with exposure light L, the surface of the photoreceptor drum 21 charged by the charger 22 so that an electrostatic latent image is formed on the surface of the photoreceptor drum 21. The exposure light L is modulated in accordance with image data received from an image signal processing unit 71 (refer to FIG. 1) of the control unit 70. The developing device 24 forms a toner image on the surface of the photoreceptor drum 21 by developing the electrostatic latent image formed on the surface of the photoreceptor drum 21 with a developer G containing a toner.

The cleaning device 25 has a blade-like shape and scrapes a toner remaining on the surface of the photoreceptor drum 21 off the surface of the photoreceptor drum 21 after transfer of the toner image to the transfer device 30. The charge erasing device 26 erases charge by irradiating the photoreceptor drum 21 with light after the transfer. Accordingly, the charging history on the surface of the photoreceptor drum 21 is canceled. The toner cartridges 27 supply toners to the developing devices 24.

The transfer device 30 primarily transfers, to the transfer belt 31, toner images on the photoreceptor drums 21 for respective colors such that the toner images are superimposed on each other and secondarily transfers, to the recording medium P, the superimposed toner images. A specific description will be made below.

The transfer belt 31 has an endless shape as shown in FIG. 2 and is wound around a plurality of rolls 32. A roll 32D functions as a driving roll that revolves the transfer belt 31 in a direction along an arrow A by means of power of a motor (not shown). In addition, a roll 32T functions as a tension applying roll that applies tension to the transfer belt 31. A lower end-side apex portion of the transfer belt 31, at which an obtuse angle is formed, is wound around a roll 32B. The roll 32B functions as a facing roll for a secondary transfer roll 34, which will be described later. The transfer belt 31 comes into contact with the photoreceptor drums 21 for the respective colors from below at the upper side portion extending in the apparatus width direction.

Inside the transfer belt 31, primary transfer rolls 33, which are examples of transfer members that transfer respective toner images of the photoreceptor drums 21 to the transfer belt 31, are disposed. Each of the primary transfer rolls 33 is disposed to face the photoreceptor drum 21 of a corresponding color with the transfer belt 31 interposed therebetween. In addition, a transfer bias voltage having a polarity opposite to a toner polarity is applied to the primary transfer roll 33. As the transfer bias voltage is applied, a toner image formed on the photoreceptor drum 21 is transferred to the transfer belt 31. Note that a density sensor 36 that detects the densities of toner images transferred onto the transfer belt 31 is provided downstream of primary transfer positions of the transfer belt 31.

In addition, the transfer device 30 includes the secondary transfer roll 34 that transfers, to the recording medium P, toner images superimposed on the transfer belt 31. The secondary transfer roll 34 is disposed such that the transfer belt 31 is interposed between the secondary transfer roll 34 and the roll 32B and forms the transfer nip NT that is formed between the secondary transfer roll 34 and the transfer belt 31. The recording medium P is supplied to the transfer nip NT from the medium supply unit 52 at an appropriate time. A transfer bias voltage having a polarity opposite to the toner polarity is applied to the secondary transfer roll 34 by an electricity supply unit (not shown). As the transfer bias voltage is applied, the toner images are transferred from the transfer belt 31 to the recording medium P passing through the transfer nip NT.

Furthermore, the transfer device 30 includes a cleaning device 35 that cleans the transfer belt 31 after secondary transfer. In a revolution direction of the transfer belt 31, the cleaning device 35 is disposed downstream of a portion (the transfer nip NT) at which secondary transfer is performed and is disposed upstream of a portion at which first transfer is performed. The cleaning device 35 includes a blade 351 and scrapes a toner remaining on a surface of the transfer belt 31 off the surface of the transfer belt 31.

The fixing device 40 fixes a toner image to the recording medium P to which the toner image is transferred at the transfer device 30. In the present exemplary embodiment, the fixing device 40 fixes the toner image to the recording medium P by heating and pressurizing the toner image at the fixation nip NF that is formed by a fixation belt 411 and a pressurization roll 42, the fixation belt 411 being wound around a plurality of rolls 413.

A roll 413H is a heating roll that includes, for example, a heater provided in the heating roll and that is rotated by a driving force transmitted from a motor (not shown). Accordingly, the fixation belt 411 circulates in a direction along an arrow R. In addition, the pressurization roll 42 is also rotated at the same circumferential speed as the fixation belt 411 by a driving force transmitted from a motor (not shown).

### Medium Transportation Device

Here, the “medium transportation device” will be described in detail.

As shown in FIG. 1, the medium transportation device 50 includes the medium supply unit 52, the medium discharge unit 54, the medium return unit 56, and the intermediate transportation unit 58.

The medium supply unit 52 includes accommodation containers 521 in which the recording mediums P are stacked and accommodated. In the present exemplary embodiment, two accommodation containers 521 are arranged in the apparatus width direction below the transfer device 30. A plurality of transportation roll pairs 522 and the like form a medium supply path 52P leading from each of the accommodation containers 521 to the transfer nip NT, which is a secondary transfer position.

Above each of the accommodation containers 521, a feeding roll 523 that feeds the uppermost recording medium P stacked in the accommodation container 521 is disposed. Of the plurality of transportation roll pairs 522, transportation roll pairs 522S that are closest to an upstream side in a transportation direction of the recording mediums P function as separation rolls that separate the recording mediums P in an one-by-one manner, the recording mediums P being fed by the feeding rolls 523 from the accommodation containers 521 such that the recording mediums P overlap with each other. The recording mediums P fed from the accommodation containers 521 are transported through supply paths 52P1 of the medium supply path 52P. In addition, of the plurality of transportation roll pairs 522, a transportation roll pair 522R that is positioned immediately upstream of the transfer nip NT in the transportation direction of the recording medium P operates such that the timing of movement of toner images on the transfer belt 31 and the timing of transportation of the recording medium P match each other.

In addition, the medium supply unit 52 includes a spare transportation path 52Pr. The spare transportation path 52Pr starts from an opening portion 91W of the first housing 91 that is on a side opposite to a second housing 92 side and joins a fold portion 52P2 of the medium supply path 52P. The spare transportation path 52Pr is a transportation path that is used in a case where the recording medium P fed from an optional recording medium supply device (not shown) disposed adjacent to the opening portion 91W of the first housing 91 is to be fed to the image forming unit 12.

The intermediate transportation unit 58 includes a plurality of belt transportation members 581 that are disposed over an area between the transfer nip NT of the transfer device 30 and the fixation nip NF of the fixing device 40 and that include endless transportation belts wound around rolls. Each of the belt transportation members 581 is configured such that the transportation belt revolves to transport the recording medium P while the recording medium P is being attracted to a surface of the transportation belt due to air being sucked (negative-pressure suction) from inside. Each belt transportation member 581 includes a plurality of rolls 582 that support the transportation belt. A transportation path 58P is formed on the belt transportation members 581.

The medium discharge unit 54 discharges the recording medium P, on which toner images are fixed by the fixing device 40 of the image forming unit 12, to the outside of the housing 90 through a discharge port 92W formed at an end portion of the second housing 92 that is on a side opposite to a first housing 91 side. The medium discharge unit 54 includes the discharged medium receiving portion 541 that receives the recording medium P discharged through the discharge port 92W.

The medium discharge unit 54 includes a medium discharge path 54P for transportation of the recording medium P from the fixing device 40 (the fixation nip NF) to the discharge port 92W. The medium discharge path 54P is formed by a belt transportation member 543, a plurality of roll pairs 542, and the like. In addition, of the plurality of roll pairs 542, a roll pair 542E that is disposed closest to a downstream side in a discharge direction of the recording medium P functions as a discharge roll that discharges the recording medium P to the discharged medium receiving portion 541.

The medium return unit 56 includes a plurality of roll pairs 561. The plurality of roll pairs 561 form an inversion path 56P to which the recording medium P passing through the image inspection unit 66 is fed in a case where there is a request to form images on both surfaces. The inversion path 56P includes a branch path 56P1, a transportation path 56P2, and an inversion path 56P3. The branch path 56P1 branches off from the medium discharge path 54P. Through the transportation path 56P2, the recording medium P received from the branch path 56P1 is fed to the medium supply path 52P. The inversion path 56P3 is provided at an intermediate portion of the transportation path 56P2 and at the inversion path 56P3, the transportation direction of the recording medium P transported through the transportation path 56P2 is reversed (the recording medium P is switchback-transported) so that the recording medium P is inverted upside down.

### Postprocessing Unit

The medium cooling unit 62, the correcting device 64, and the image inspection unit 66 constituting the postprocessing unit 60 are arranged in this order from an upstream side in the discharge direction while being disposed upstream of a portion of the medium discharge path 54P of the medium discharge unit 54, at which the branch path 56P1 branches off, in the discharge direction of the recording medium P.

The medium cooling unit 62 includes a heat absorbing device 621 that absorbs heat of the recording medium P and a pressing device 622 that presses the recording medium P against the heat absorbing device 621. The heat absorbing device 621 is disposed on an upper side with respect to the medium discharge path 54P, and the pressing device 622 is disposed on a lower side with respect to the medium discharge path 54P.

The heat absorbing device 621 includes an endless heat absorption belt 6211, a plurality of rolls 6212 that support the heat absorption belt 6211, a heat sink 6213 that is disposed inside the heat absorption belt 6211, and a fan 6214 that cools the heat sink 6213. An outer peripheral surface of the heat absorption belt 6211 comes into contact with the recording medium P such that heat can be exchanged. Of the plurality of rolls 6212, a roll 6212D functions as a driving roll that transmits a driving force to the heat absorption belt 6211. Over a predetermined area along the medium discharge path 54P, the heat sink 6213 is in surface contact with an inner peripheral surface of the heat absorption belt 6211 to be slidable.

The pressing device 622 includes an endless pressing belt 6221 and a plurality of rolls 6222 that support the pressing belt 6221. The pressing belt 6221 is wound around the plurality of rolls 6222. The pressing device 622 transports the recording medium P together with the heat absorption belt 6211 while pressing the recording medium P against the heat absorption belt 6211 (the heat sink 6213).

The correcting device 64 is provided downstream of the medium cooling unit 62 in the medium discharge unit 54. The correcting device 64 corrects a bend (a curl) of the recording medium P received from the medium cooling unit 62. In addition, an inline sensor 661 constituting a major part of the image inspection unit 66 is disposed downstream of the correcting device 64 in the medium discharge unit 54. The inline sensor 661 detects, based on light emitted to the recording medium P and reflected from the recording medium P, the presence or absence and the degree of a toner density defect, an image defect, an image position defect, or the like of a fixed toner image.

### Configuration of Cyclone Device

Next, an example of the configuration of a cyclone device of the first exemplary embodiment will be described.

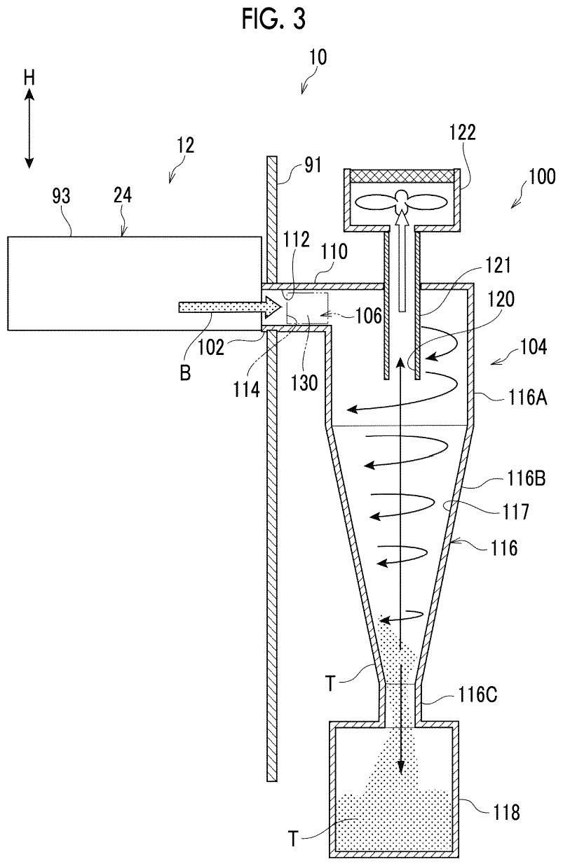

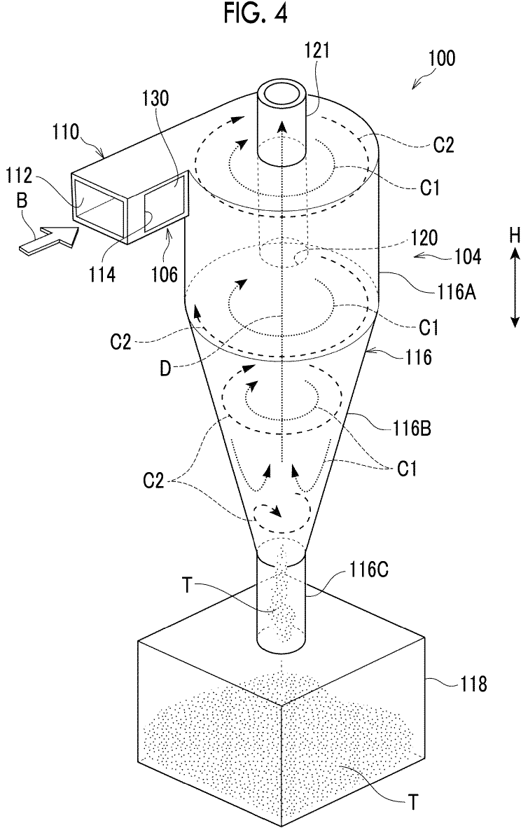

FIG. 3 is a cross-sectional view showing an example of the configuration of the cyclone device 100. FIG. 4 is a schematic perspective view showing the flow of air and toner in the cyclone device 100.

As shown in FIG. 3, the image forming system 10 is provided with the cyclone device 100. The cyclone device 100 includes an air transfer path 102, a cyclone capturing unit 104, and an opening and closing portion 106.

The air transfer path 102 leads to the outside of the first housing 91 from the image forming unit 12 in the first housing 91. The first housing 91 is an example of a housing. For example, air containing the toner T in the image forming unit 12 is transferred to the air transfer path 102. In the cyclone device 100, for example, an upstream-side end portion of the air transfer path 102 in an air transfer direction is connected to a housing 93 of the developing device 24 disposed in the image forming unit 12. Although not shown, the air transfer path 102 may be configured such that four branch paths connected to the developing devices 24 of yellow (Y), magenta (M), cyan (C), and black (K) join one air transfer path, for example.

The cyclone capturing unit 104 includes a first suction port 112, a second suction port 114, a cyclone container 116, a collection container 118, and a gas outlet port 120. The collection container 118 is an example of a collection portion. In addition, the cyclone capturing unit 104 includes a gas discharge fan 122 which is an example of a sending device.

The cyclone capturing unit 104 includes a suction path 110 connected to the air transfer path 102. The first suction port 112 is an opening provided in the suction path 110 and air containing the toner T in the image forming unit 12 is sucked via the air transfer path 102. In the cyclone device 100 of the first exemplary embodiment, the first suction port 112 is connected to the developing device 24 via the air transfer path 102 and air containing the toner T in the housing 93 of the developing device 24 is sucked through the first suction port 112 in a direction along an arrow B.

Through the second suction port 114, air different from the air sucked in through the first suction port 112 is sucked from the outside of the image forming unit 12. For example, air outside the first housing 91, in which the image forming unit 12 is disposed, is sucked through the second suction port 114. The second suction port 114 is provided at, for example, a side wall of the suction path 110 outside the first housing 91 and fresh air outside the first housing 91 is sucked through the second suction port 114. In the cyclone device 100 of the first exemplary embodiment, the first suction port 112 and the second suction port 114 are provided at an upper portion of the cyclone container 116.

The cyclone container 116 is a tubular container in which air sucked in from the suction path 110 is swirled. The cyclone container 116 includes a cylindrical portion 116A that is disposed at an upper portion in a vertical direction, an inverted conical portion 116B that is disposed at an intermediate portion in the vertical direction, and a discharge path 116C that is disposed at a lower portion in the vertical direction. The cylindrical portion 116A, the inverted conical portion 116B, and the discharge path 116C are connected to each other in the vertical direction, so that internal spaces thereof are connected to each other.

The cylindrical portion 116A has a cylindrical outer shape as seen in a plan view (refer to FIG. 4). The inner diameter of the cylindrical portion 116A is larger than the inner diameter of a portion of the cyclone container 116 other than the cylindrical portion 116A. For example, the inner diameter of the cylindrical portion 116A is uniform in the vertical direction.

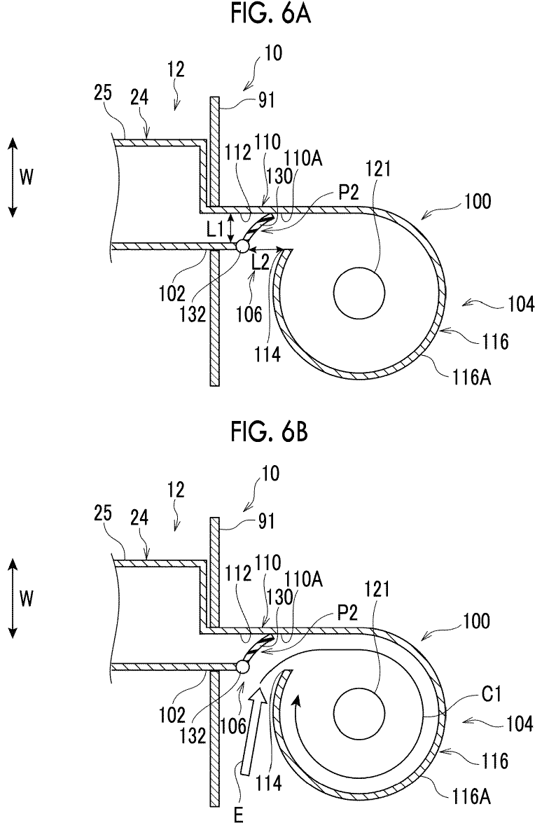

The suction path 110 is connected to the cylindrical portion 116A. For example, the suction path 110 extends in a direction that is tangent to the cylindrical portion 116A (refer to FIGS. 4, 5, 6A, and 6B). The suction path 110 is, for example, a rectangular tubular portion (refer to FIG. 4). The suction path 110 is provided with the first suction port 112 that is open in the direction tangent to the cylindrical portion 116A and the second suction port 114 that is formed at the side wall of the suction path 110. In the suction path 110, the first suction port 112 and the second suction port 114 are disposed in directions intersecting each other. For example, the second suction port 114 is provided at a position adjacent to the cylindrical portion 116A in the suction path 110. Accordingly, as represented by an arrow E, it is possible to cause air to flow into the cylindrical portion 116A through the second suction port 114 in a direction that is tangent to the cylindrical portion 116A (refer to FIG. 6B).

The inverted conical portion 116B is connected to a lower end portion of the cylindrical portion 116A. The inverted conical portion 116B has an inverted-conical shape of which the inner diameter gradually decreases from an upper portion side toward a lower portion side in the vertical direction. An inclined surface 117 that is inclined with respect to the horizontal direction as seen in a side view is provided inside the inverted conical portion 116B. In the cyclone container 116, the angle of the inclined surface 117 with respect to the horizontal direction is an obtuse angle.

The discharge path 116C is a cylindrical tubular portion and is connected to a lower end portion of the inverted conical portion 116B. For example, the inner diameter of the discharge path 116C is uniform in the vertical direction.

The collection container 118 is connected to a lower portion of the cyclone container 116, that is, a lower end portion of the discharge path 116C. The collection container 118 collects the toner. For example, the outer shape of the collection container 118 is larger than the outer shape of the discharge path 116C. The collection container 118 may be configured to be removable with respect to the cyclone container 116.

A gas discharge pipe 121 is provided at an upper portion of the cyclone container 116. For example, a lower portion of the gas discharge pipe 121 is the gas outlet port 120 that is open in the cylindrical portion 116A of the cyclone container 116. Through the gas outlet port 120, air in the cyclone container 116 is discharged. For example, the gas discharge pipe 121 is disposed along the vertical direction at a central portion in the cylindrical portion 116A. That is, the gas discharge pipe 121 extends in a direction away from an upper surface of the cylindrical portion 116A. In addition, a gas discharge direction of the gas discharge pipe 121 intersects a suction direction of the suction path 110. For example, the gas outlet port 120 is provided in a direction intersecting the first suction port 112 and the second suction port 114.

The gas discharge fan 122 is provided at an upper end portion of the gas discharge pipe 121. The upper end portion of the gas discharge pipe 121 is a downstream-side end portion in a direction in which air flows due to the gas discharge fan 122. The gas discharge fan 122 rotates such that air is sucked into the cyclone container 116 and causes the air to swirl in the cyclone container 116 such that an air stream to be discharged through the gas outlet port 120 is generated. For example, the gas discharge fan 122 discharges air in the cyclone container 116 upward.

As shown in FIGS. 3 and 4, in the cyclone capturing unit 104, the gas discharge fan 122 is rotated such that air is sucked into the cyclone container 116 through the first suction port 112 and the second suction port 114. Then, the air and the toner T are swirled in the cyclone container 116 such that the toner T and the air are separated from each other due to a centrifugal force. For example, as shown in FIG. 4, the air swirls in the inverted conical portion 116B of the cyclone container 116 as represented by an arrow C1 having a small radius, and the toner T swirls as represented by an arrow C2 having a large radius. Accordingly, the air and the toner T are separated from each other, and the toner T is captured and collected into the collection container 118. In the cyclone capturing unit 104, the toner T is collected into the collection container 118 below the cyclone container 116 due to gravity. As represented by an arrow D, the air from which the toner T has been separated is discharged through the gas outlet port 120 provided at an upper portion.

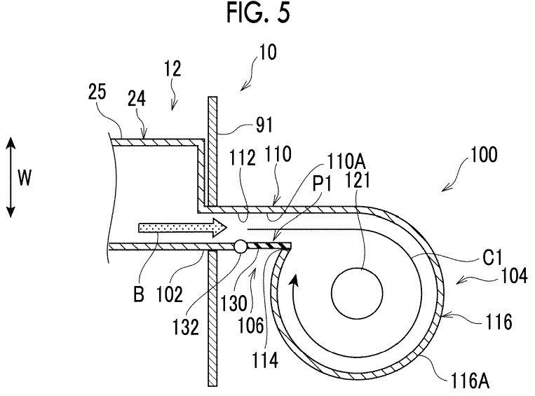

FIG. 5 is a cross-sectional plan view that shows an example of the configuration of the opening and closing portion 106 and that shows a state where the first suction port 112 is open. FIGS. 6A and 6B are cross-sectional plan views that show the example of the configuration of the opening and closing portion 106 and that show a state where the second suction port 114 is open.

As shown in FIGS. 5, 6A, and 6B, the opening and closing portion 106 opens only one of the first suction port 112 and the second suction port 114 and closes the other of the first suction port 112 and the second suction port 114. In addition, the opening and closing portion 106 opens only the second suction port 114 in the case of cleaning of the cyclone capturing unit 104.

For example, the opening and closing portion 106 includes a single opening and closing member 130. The opening and closing member 130 is rotatable by a rotary shaft 132. The rotary shaft 132 is disposed along the vertical direction. The opening and closing member 130 is movable to a first position P1 (refer to FIG. 5) at which the opening and closing member 130 opens the first suction port 112 and closes the second suction port 114 and a second position P2 (refer to FIG. 6A and the like) at which the opening and closing member 130 opens the second suction port 114 and closes the first suction port 112. That is, the opening and closing member 130 rotates between the first position P1 (refer to FIG. 5) and the second position P2 (refer to FIG. 6A and the like) as the rotary shaft 132 rotates.

As shown in FIG. 6A, an opening diameter L1 of the first suction port 112 in the horizontal direction is smaller than an opening diameter L2 of the second suction port 114 in the horizontal direction. In addition, for example, the opening diameter of the first suction port 112 in the vertical direction is equal to the opening diameter of the second suction port 114 in the vertical direction. Therefore, the opening area of the second suction port 114 is larger than the opening area of the first suction port 112. Regarding the gas discharge fan 122, the fan rotates at the same rotation speed regardless of whether the first suction port 112 is open or the second suction port 114 is open, so that the speed of wind blowing in a case where the second suction port 114 is open is made higher than the speed of wind blowing in a case where the first suction port 112 is open.

In addition, the opening and closing member 130 has elasticity. For example, the opening and closing member 130 is formed of a rubber member. The opening diameter L1 of the first suction port 112 in the horizontal direction is smaller than the opening diameter L2 of the second suction port 114 in the horizontal direction, and the opening and closing member 130 is formed to have a dimension enough to close the second suction port 114 in a case where the opening and closing member 130 is moved to the first position P1 (refer to FIG. 5). Accordingly, as shown in FIG. 6A, the opening and closing member 130 is deformable into a curved shape by coming into contact with an inner wall 110A of the suction path 110 in a case where the opening and closing member 130 is moved to the second position P2 to open the second suction port 114. An air suction path from the second suction port 114 is formed by a recessed curved surface formed in a case where the opening and closing member 130 is deformed into the curved shape. That is, since the opening and closing member 130 is deformed, an inner side of a suction path through which air is sucked in a case where the second suction port 114 is open has a curved shape open to an internal portion of the suction path.

### Hardware Configuration of Image Forming System

Next, a hardware configuration of the image forming system 10 will be described.

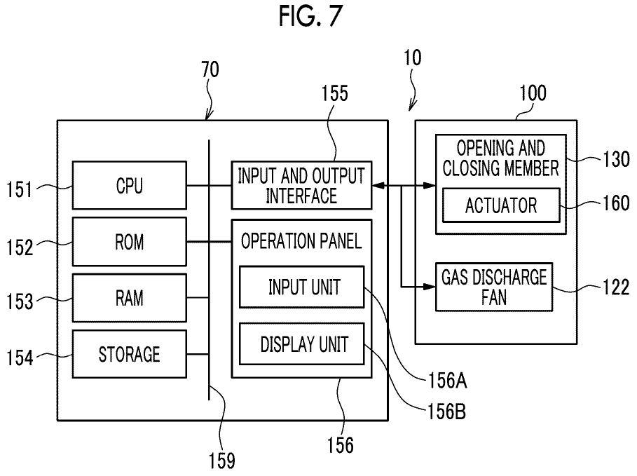

FIG. 7 is a block diagram showing a hardware configuration of the image forming system 10. Only a configuration related to the present disclosure is shown in FIG. 7 and a configuration not related to the present disclosure is not shown.

As shown in FIG. 7, the image forming system 10 includes the control unit 70 and the cyclone device 100. The control unit 70 includes a central processing unit (CPU) 151, a read only memory (ROM) 152, a random access memory (RAM) 153, a storage 154, an input and output interface 155, and an operation panel 156 as components thereof. The components are connected to each other via a bus 159 such that the components can communicate with each other.

The CPU 151 is a central processing unit and executes various programs or controls each unit. The CPU 151 is an example of a processor. That is, the CPU 151 reads out a program from the ROM 152 or the storage 154, and executes the program by using the RAM 153 as a working area. The CPU 151 controls each of the above-described components and performs various types of arithmetic processes according to the program recorded on the ROM 152 or the storage 154. In the first exemplary embodiment, the ROM 152 or the storage 154 stores a driving program of the cyclone device 100.

The ROM 152 stores various programs and various types of data. The RAM 153 temporarily stores programs or data as a work area. The storage 154 is composed of a hard disk drive (HDD) or a solid state drive (SSD) and stores various programs including an operating system and various types of data. For example, a program of a printer driver is stored in the ROM 152 or the storage 154. The CPU 151 reads out the program of the printer driver from the ROM 152 or the storage 154 and executes the program to function as the printer driver.

The input and output interface 155 is an interface for transmission and reception of information and the like to and from each of the components mounted in the image forming system 10. For example, the input and output interface 155 is electrically connected to an actuator 160 that drives the rotary shaft 132 of the opening and closing member 130 and the gas discharge fan 122 in the cyclone device 100. Accordingly, the CPU 151 controls, based on the driving program of the cyclone device 100 stored in the ROM 152 or the storage 154, the operation of the actuator 160 and the gas discharge fan 122. The way in which the actuator 160 operates the opening and closing member 130 will be described later.

The operation panel 156 includes an input unit 156A and a display unit 156B. Through the input unit 156A, various input operations such as issuing an instruction to perform printing are performed. The display unit 156B is, for example, a liquid crystal display and displays various types of information. A touch panel type display unit is adopted as the display unit 156B and a part of the display unit 156B functions as the input unit 156A. Note that the operation panel 156 may be configured to be electrically connected via the input and output interface 155.

### Image Forming System of Comparative Example

Here, an image forming system of a comparative example will be described.

Although not shown, the image forming system of the comparative example includes a cyclone device into which only air containing toner in a developing device is introduced.

In the image forming system of the comparative example, the air and the toner are separated from each other by a centrifugal force caused by a swirling stream of the air in a cyclone container provided for the cyclone device, the toner is collected into a collection container on a lower side, and the air separated from the toner is discharged from an upper side. During such a process, the toner adheres to a wall surface in the cyclone container, which causes a decrease in toner collection rate.

For prevention of a decrease in collection rate that is caused by adhesion of toner to the wall surface in the cyclone container, it is necessary to regularly perform an operation of cleaning the cyclone container. However, installation of a new cleaning member in the cyclone container results in an increase in cost. In addition, in the case of cleaning in which an airflow in the cyclone container is utilized, it is difficult to efficiently clean the cyclone container due to toner cloud in a developing device is mixed with the airflow in a case where an airflow is introduced from the developing device in the same manner as in the case of a normal operation. Particularly, in the image forming system forming an image at a high speed, toner cloud is likely to stay in the developing device and thus an airflow passing through the developing device is not appropriate for cleaning of the cyclone container.

### Operation of Opening and Closing Portion

Next, the operation of the opening and closing portion 106 in the image forming system 10 of the first exemplary embodiment will be described.

The image forming system 10 includes the opening and closing portion 106 as described above. The opening and closing portion 106 opens only one of the first suction port 112 and the second suction port 114, closes the other of the first suction port 112 and the second suction port 114, and opens only the second suction port 114 in the case of cleaning of the cyclone capturing unit 104. The opening and closing portion 106 includes the opening and closing member 130, and the opening and closing member 130 is rotated by the rotary shaft 132.

The actuator 160 (refer to FIG. 7) drives the rotary shaft 132 to move the opening and closing member 130 to the first position P1 or the second position P2. For example, in the case of a normal operation (for example, a normal mode in the case of normal image formation), the CPU 151 (refer to FIG. 7) causes the actuator 160 to move the opening and closing member 130 to the first position P1 (refer to FIG. 5) so that the first suction port 112 is opened. In this case, the opening and closing member 130 closes the second suction port 114.

The gas discharge fan 122 is rotated at a determined time in such a state, so that air containing the toner T (that is, toner cloud) in the developing device 24 is sent to the cyclone capturing unit 104 via the first suction port 112. Then, the air is caused to swirl in the cyclone capturing unit 104 so that the toner T and the air are separated from each other due to a centrifugal force. Accordingly, the toner T is captured and collected into the collection container 118 on a lower portion side of the cyclone container 116. The air from which the toner T has been separated is discharged through the gas outlet port 120 provided at an upper portion side of the cyclone container 116.

In addition, in the case of cleaning of the cyclone capturing unit 104 (for example, a cleaning mode), the CPU 151 causes the actuator 160 to move the opening and closing member 130 to move to the second position P2 so that the second suction port 114 is opened. In this case, the opening and closing member 130 closes the first suction port 112 to block an airflow from the developing device 24 side. The gas discharge fan 122 is rotated in such a state, so that air (that is, fresh air) outside the first housing 91 is introduced into the cyclone capturing unit 104 via the second suction port 114. Then, the air is caused to swirl in the cyclone capturing unit 104 so that dirt and the air are separated from each other due to a centrifugal force. Accordingly, the dirt containing the toner T is captured and collected into the collection container 118 on the lower portion side of the cyclone container 116. The air from which the dirt such as the toner T has been separated is discharged through the gas outlet port 120 provided at the upper portion side of the cyclone container 116. In this case, a large volume of wind with a small pressure loss, which is the air (that is, the fresh air) outside the first housing 91, is sent into the cyclone capturing unit 104 so that toner adhering to the wall surface of the cyclone capturing unit 104 is efficiently removed.

### Actions and Effects

Next, actions of the first exemplary embodiment will be described.

The image forming system 10 of the first exemplary embodiment includes the image forming unit 12 and the cyclone capturing unit 104. The cyclone capturing unit 104 includes the first suction port 112 through which air containing the toner T in the image forming unit 12 is sucked and the second suction port 114 through which air different from the air sucked through the first suction port 112 is sucked from the outside of the image forming unit 12. Furthermore, the cyclone capturing unit 104 includes the cyclone container 116, the collection container 118 that collects the toner T, the gas outlet port 120 for discharge of the air, and the gas discharge fan 122.

In the cyclone capturing unit 104, the air sucked into the cyclone container 116 through the first suction port 112 or the second suction port 114 is swirled such that the air and the toner are separated from each other due to a centrifugal force, the toner is captured and collected into the collection container 118, and the air is discharged through the gas outlet port 120.

In addition, the image forming system 10 includes the opening and closing portion 106 that opens only one of the first suction port 112 and the second suction port 114 and closes the other of the first suction port 112 and the second suction port 114. The opening and closing portion 106 opens only the second suction port 114 in the case of cleaning of the cyclone capturing unit 104.

For example, in the image forming system 10, in the case of a normal operation, the opening and closing member 130 is moved to the first position P1 so that the first suction port 112 is opened and the second suction port 114 is closed as shown in FIG. 5. Then, the gas discharge fan 122 is rotated at a determined time, so that air containing the toner T in the developing device 24 is introduced into the cyclone capturing unit 104 via the first suction port 112 as represented by the arrow B. Furthermore, the air and the toner T are separated from each other by a centrifugal force caused by a swirling stream of the air in the cyclone capturing unit 104. Accordingly, the toner T is captured and collected into the collection container 118 and the air separated from the toner T is discharged through the gas outlet port 120.

In addition, in the image forming system 10, in the case of cleaning of the cyclone capturing unit 104, the opening and closing member 130 is moved to the second position P2 so that only the second suction port 114 is opened as shown in FIG. 6B. That is, the opening and closing member 130 closes the first suction port 112. Then, the gas discharge fan 122 is rotated so that air (that is, fresh air) outside the first housing 91 is introduced into the cyclone capturing unit 104 via the second suction port 114 as represented by the arrow E. Furthermore, the air and dirt such as the toner T are separated from each other by a centrifugal force caused by a swirling stream of the air in the cyclone capturing unit 104. Accordingly, the dirt containing the toner T is captured and collected into the collection container 118 and the air separated from the dirt such as the toner T is discharged through the gas outlet port 120.

Therefore, in the image forming system 10, toner adhering to the wall surface of the cyclone capturing unit 104 may be efficiently removed in comparison with a case where air containing the toner in the image forming unit is sucked into the cyclone capturing unit in the case of cleaning.

In addition, in the image forming system 10, the cyclone capturing unit 104 includes the cyclone container 116 in which air sucked into the cyclone container 116 is caused to swirl and that has a tubular shape. In addition, an upper portion of the cyclone container 116 is provided with the first suction port 112 and the second suction port 114 and the collection container 118 is connected to a lower portion of the cyclone container 116. Furthermore, the gas outlet port 120 is provided in a direction intersecting the first suction port 112 and the second suction port 114 at the upper portion of the cyclone container 116.

Accordingly, the air and the toner T are separated from each other by a centrifugal force caused by a swirling stream of the air sucked into the cyclone container 116 through the first suction port 112 and the second suction port 114. Then, the toner T is collected into the collection container 118 on the lower portion side of the cyclone container 116 due to gravity and the air from which the toner T has been separated is discharged through the gas outlet port 120 provided on the upper portion side of the cyclone container 116. Therefore, in the image forming system 10, the efficiency of removal (that is, the efficiency of elimination) of toner adhering to the cyclone container 116 is high in comparison with a case where a second gas inlet port and a gas outlet port face the same side.

In addition, in the image forming system 10, the image forming unit 12 includes the developing device 24 that develops an electrostatic latent image on a surface of the photoreceptor drum 21 with the toner T. Regarding the cyclone capturing unit 104, the first suction port 112 is connected to the developing device 24 and air containing the toner T in the developing device 24 is sucked through the first suction port 112. Therefore, in the image forming system 10, the toner T contained in the air is easily collected by the cyclone capturing unit 104 in comparison with a case where air outside the developing device is sucked through the first suction port.

In addition, in the image forming system 10, air outside the first housing 91, in which the image forming unit 12 is disposed, is sucked through the second suction port 114. Therefore, in the image forming system 10, toner adhering to the wall surface of the cyclone capturing unit 104 may be efficiently removed in comparison with a case where air in the first housing including the image forming unit is sucked through the second suction port.

In addition, the opening and closing portion 106 includes a single opening and closing member 130 that is movable to the first position P1 at which the opening and closing member 130 opens the first suction port 112 and closes the second suction port 114 and the second position P2 at which the opening and closing member 130 opens the second suction port 114 and closes the first suction port 112 (refer to FIGS. 5 and 6B). Therefore, in the image forming system 10, the structure may be simplified in comparison with a case where two opening and closing members that respectively open and close the first suction port and the second suction port are provided.

In addition, the opening and closing member 130 is configured to rotate between the first position P1 and the second position P2 (refer to FIGS. 5 and 6B). Therefore, in the image forming system 10, the structure may be simplified in comparison with a case where the opening and closing member is slid to move to the first position and the second position.

In addition, in the image forming system 10, the cyclone capturing unit 104 includes the gas discharge fan 122 that causes the air sucked into the cyclone capturing unit 104 to swirl such that an air stream to be discharged through the gas outlet port 120 is generated. The gas discharge fan 122 makes the speed of wind blowing in a case where the second suction port 114 is open higher than the speed of wind blowing in a case where the first suction port 112 is open. Therefore, in the image forming system 10, toner adhering to the wall surface of the cyclone capturing unit 104 may be efficiently removed in the case of cleaning in comparison with a case where the speed of wind blowing in a case where the second suction port is open and the speed of wind blowing in a case where the first suction port is open are equal to each other.

In addition, in the image forming system 10, the opening area of the second suction port 114 is larger than the opening area of the first suction port 112. Therefore, in the image forming system 10, toner adhering to the wall surface of the cyclone capturing unit 104 may be efficiently removed in the case of cleaning in comparison with a case where the opening area of the second suction port and the opening area of the first suction port are equal to each other.

In addition, in the image forming system 10, the opening and closing portion 106 is configured such that an inner side of a suction path through which air is sucked in a case where the second suction port 114 is open has a curved shape open to an internal portion of the suction path. Therefore, in the image forming system 10, air easily flows in through the second suction port 114 in comparison with a case where the inner side of the suction path through which air is sucked in a case where the second suction port is open is a linear surface extending along an inflow direction.

In addition, in the image forming system 10, the opening and closing portion 106 includes the opening and closing member 130 that has elasticity and that opens and closes the second suction port 114. The opening and closing member 130 is deformable into a curved shape by coming into contact with the inner wall 110A of the suction path 110 in a case where the second suction port 114 is opened. Therefore, in the image forming system 10, the opening and closing member 130 is easily deformed into a curved shape in comparison with a case where the opening and closing member is more difficult to deform than the inner wall.

### Supplementary Description

In the image forming system 10 of the first exemplary embodiment, the air transfer path 102 that connects the developing device 24 and the cyclone capturing unit 104 to each other is provided. However, the present disclosure is not limited to such a configuration. For example, the configuration of the air transfer path can be changed as long as a configuration in which the inside of the image forming unit 12 and the cyclone capturing unit are connected to each other is adopted.

In the image forming system 10 of the first exemplary embodiment, the opening and closing member 130 made of rubber is provided. However, the present disclosure is not limited to such a configuration. The configuration of the opening and closing member can be changed. For example, a configuration may also be adopted in which an opening and closing member consisting of a deformable metal plate spring is provided as an opening and closing member having elasticity and the opening and closing member is deformed into a curved shape by coming into contact with the inner wall in a case where the opening and closing member is moved to the first position. In addition, a configuration in which the opening and closing member is not deformed in a case where the opening and closing member is moved to the first position may also be adopted.

In addition, in the image forming system 10 of the first exemplary embodiment, the single opening and closing member 130 is provided. However, the present disclosure is not limited to such a configuration. For example, a configuration may also be adopted in which two opening and closing members that open and close the first suction port and the second suction port, respectively, are provided.

Note that, although a specific exemplary embodiment of the present invention has been described in detail, the present invention is not limited to the exemplary embodiment and it is obvious to persons skilled in the art that other various exemplary embodiments are possible without departing from the scope of the present invention.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

### SUPPLEMENTARY NOTES

Regarding the above-described exemplary embodiment, the following supplementary notes will be further disclosed.
(((1)))

An image forming system comprising:
an image forming unit that forms an image on a medium using toner;
a cyclone capturing unit that includes a first suction port through which air containing the toner in the image forming unit is sucked, a second suction port through which air different from the air sucked through the first suction port is sucked from an outside of the image forming unit, a collection portion that collects the toner, and a gas outlet port for discharge of the air and in which the air sucked into the cyclone capturing unit through the first suction port or the second suction port is swirled such that the air and the toner are separated from each other due to a centrifugal force, the toner is captured and collected into the collection portion, and the air is discharged through the gas outlet port; and
an opening and closing portion that opens only one of the first suction port and the second suction port, that closes the other of the first suction port and the second suction port, and that opens only the second suction port in a case of cleaning.
(((2)))

The image forming system according to (((1))),
wherein the cyclone capturing unit includes a container in which air sucked into the container is caused to swirl and that has a tubular shape,
an upper portion of the container is provided with the first suction port and the second suction port,
the collection portion is connected to a lower portion of the container, and
the gas outlet port is provided in a direction intersecting the first suction port and the second suction port at the upper portion of the container.
(((3)))

The image forming system according to (((1))) or (((2))),
wherein the image forming unit includes a developing device that develops an electrostatic latent image on a surface of a photoreceptor with the toner,
the first suction port is connected to the developing device, and
air containing the toner in the developing device is sucked through the first suction port.
(((4)))

The image forming system according to (((3))),
wherein air outside a housing, in which the image forming unit is disposed, is sucked through the second suction port.
(((5)))

The image forming system according to any one of (((1))) to (((4))),
wherein the opening and closing portion includes a single opening and closing member that is movable to a first position at which the opening and closing member opens the first suction port and closes the second suction port and a second position at which the opening and closing member opens the second suction port and closes the first suction port.
(((6)))

The image forming system according to (((5))),
wherein the opening and closing member is configured to rotate between the first position and the second position.
(((7)))

The image forming system according to any one of (((1))) to (((6))),
wherein the cyclone capturing unit includes an air blowing device that causes the air sucked into the cyclone capturing unit to swirl such that an air stream to be discharged through the gas outlet port is generated, and
the air blowing device makes a speed of wind blowing in a case where the second suction port is open higher than a speed of wind blowing in a case where the first suction port is open.
(((8)))

The image forming system according to any one of (((1))) to (((7))),
wherein an opening area of the second suction port is larger than an opening area of the first suction port.
(((9)))

The image forming system according to any one of (((1))) to (((8))),
wherein the opening and closing portion is configured such that an inner side of a suction path through which air is sucked in a case where the second suction port is open has a curved shape open to an internal portion of the suction path.
(((10)))

The image forming system according to (((9))),
wherein the opening and closing portion includes an opening and closing member that has elasticity and that opens and closes the second suction port, and
the opening and closing member is deformable into the curved shape by coming into contact with an inner wall in a case where the second suction port is opened.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image forming unit that forms an image on a medium using toner;
a cyclone capturing unit that includes a first suction port through which air containing the toner in the image forming unit is sucked, a second suction port through which air different from the air sucked through the first suction port is sucked from an outside of the image forming unit, a collection portion that collects the toner, and a gas outlet port for discharge of the air and in which the air sucked into the cyclone capturing unit through the first suction port or the second suction port is swirled such that the air and the toner are separated from each other due to a centrifugal force, the toner is captured and collected into the collection portion, and the air is discharged through the gas outlet port; and
an opening and closing portion that opens only one of the first suction port and the second suction port, that closes the other of the first suction port and the second suction port, and that opens only the second suction port in a case of cleaning.

2. The image forming system according to claim 1,
wherein the cyclone capturing unit includes a container in which air sucked into the container is caused to swirl and that has a tubular shape,
an upper portion of the container is provided with the first suction port and the second suction port,
the collection portion is connected to a lower portion of the container, and
the gas outlet port is provided in a direction intersecting the first suction port and the second suction port at the upper portion of the container.

3. The image forming system according to claim 1,
wherein the image forming unit includes a developing device that develops an electrostatic latent image on a surface of a photoreceptor with the toner,
the first suction port is connected to the developing device, and
air containing the toner in the developing device is sucked through the first suction port.

4. The image forming system according to claim 3,
wherein air outside a housing, in which the image forming unit is disposed, is sucked through the second suction port.

5. The image forming system according to claim 1,
wherein the opening and closing portion includes a single opening and closing member that is movable to a first position at which the opening and closing member opens the first suction port and closes the second suction port and a second position at which the opening and closing member opens the second suction port and closes the first suction port.

6. The image forming system according to claim 5,
wherein the opening and closing member is configured to rotate between the first position and the second position.

7. The image forming system according to claim 1,
wherein the cyclone capturing unit includes an air blowing device that causes the air sucked into the cyclone capturing unit to swirl such that an air stream to be discharged through the gas outlet port is generated, and
the air blowing device makes a speed of wind blowing in a case where the second suction port is open higher than a speed of wind blowing in a case where the first suction port is open.

8. The image forming system according to claim 1,
wherein an opening area of the second suction port is larger than an opening area of the first suction port.

9. The image forming system according to claim 1,
wherein the opening and closing portion is configured such that an inner side of a suction path through which air is sucked in a case where the second suction port is open has a curved shape open to an internal portion of the suction path.

10. The image forming system according to claim 9,
wherein the opening and closing portion includes an opening and closing member that has elasticity and that opens and closes the second suction port, and
the opening and closing member is deformable into the curved shape by coming into contact with an inner wall in a case where the second suction port is opened.
